(19) United States
(12) Patent Application Publication
(10) Pub. No.: US 2026/0195693 A1
(43) Pub. Date: Jul. 9, 2026

(54) SYSTEM AND METHOD FOR CUSTOMER INTERACTION INSIGHTS GENERATION

(71) Applicant: NICE LTD., Ra'anana (IL)

(72) Inventors: Yaron Cohen, Modiin (IL); Galit Zilberman, Ra'anana (IL); Barak Amihud, Ra'anana (IL)

(21) Appl. No.: 19/010,946

(22) Filed: Jan. 6, 2025

(51) Int. Cl. G06Q 10/0639; G06F 40/186; G06Q 30/01

(52) U.S. Cl. CPC G06Q 10/0639; G06F 40/186; G06Q 30/01

(57) ABSTRACT

Method and system of customer interaction insights generation, and non-transitory computer readable media, include selecting, by a user, an interaction between a customer and a contact center agent; receiving input data comprising interaction information about the selected interaction, wherein the input data is generated based on analyzing a transcript of the selected interaction using a template associated with the user, and wherein the template comprises a set of interaction characteristics that may be of particular interest to the user, and a set of predetermined thresholds based on the set of interaction characteristics; analyzing the interaction information using the set of predetermined thresholds for the set of interaction characteristics; generating an initial prompt for a large language model to generate interaction insights for the selected interaction; and providing the interaction insights to the user for analysis.

### COPYRIGHT NOTICE

A portion of the disclosure of this patent document contains material which is subject to copyright protection. The copyright owner has no objection to the facsimile reproduction by anyone of the patent document or the patent disclosure, as it appears in the U. S. Patent and Trademark Office patent file or records, but otherwise reserves all copyright rights whatsoever.

### TECHNICAL FIELD

The present disclosure relates generally to methods and systems of customer interaction insights generation, and more specifically relates to methods and systems of generating customer interaction insights by analyzing selected interactions between a customer and a contact center agent using user-specific criteria.

### BACKGROUND

The subject matter discussed in this background section should not be assumed to be prior art merely as a result of its mention herein. Similarly, a problem mentioned in this background section or associated with the subject matter of the background section should not be assumed to have been previously recognized (or be conventional or well-known) in the prior art. The subject matter in this background section merely represents different approaches, which in and of themselves may also be inventions.

Analyzing interactions between a customer and contact center agent is critical for any contact center organization. Such analysis allows the contact center organization to obtain insights regarding overall customer satisfaction, identify areas of improvement, assess training needs, and overall to optimize quality of service. Generating such customer interaction insights can be time-intensive for users of such insights within a contact center organization, as each interaction must be played back to the user, and analyzed to understand various contexts. Further, an interaction may need to be assessed rapidly in certain situations, for example where an angry customer has been transferred from a contact center agent to the agent's supervisor, who now has only a couple minutes to review all of the customer's prior interactions with the contact center agent.

Further, users may wish to generate interaction insights in order to achieve various goals. For example, two users may wish to generate entirely different interaction insights for the same customer interaction, based on the user's role within the contact center organization. Alternatively, a user may wish to generate interaction insights of one type for one set of customer interactions, and a different type of interaction insights for the same or different set of customer interactions. The interaction characteristics assessed by a user, and their corresponding thresholds, to generate interaction insights may change over time, may change based on the user's intended use of the insights, or may change based on insights generated for other or prior interactions.

There exist methods involving use of artificial intelligence (AI) machines to generate overall interaction summaries, however, these methods do not allow for customization of the interaction insights generated in a manner that is tailored to the user's role. These methods lack the ability for a user to quickly generate concise interaction insights for one or more interactions that are focused on the user's end-goal in using the insights (e.g., understanding training needs, quality management, etc.) Further, these methods lack the ability for a user to control the interaction characteristics that are used in generating the insights, such that a same user or two different users may assess the same set of interactions in different manners, according to their desired uses.

Accordingly, there is a need for a system that can streamline the process for generation of interaction insights that allows for the generated insights to be tailored based on a user's role within a contact center organization, or based on user's desired use of the insights.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion. In the figures, elements having the same designations have the same or similar functions.

FIG. 1 is a simplified data flow in a system according to various aspects of the present disclosure.

FIG. 2 is a flowchart of a method of customer interaction insights generation according to embodiments of the present disclosure.

FIGS. 3A and 3B illustrate exemplary views of a user interface for receiving interaction insights generated by the system according to embodiments of the present disclosure.

FIG. 4 illustrates an exemplary user interface that allows a user to filter interaction insights generated for a set of interactions by the system according to embodiments of the present disclosure.

FIG. 5 illustrates exemplary data flows for how generated interaction insights may be used by various users of the system according to embodiments of the present disclosure.

FIG. 6 illustrates exemplary improvements in customer interaction analysis in an exemplary contact center organization environment using the system according to embodiments of the present disclosure.

### DETAILED DESCRIPTION

This description and the accompanying drawings that illustrate aspects, embodiments, implementations, or applications should not be taken as limiting—the claims define the protected invention. Various mechanical, compositional, structural, electrical, and operational changes may be made without departing from the spirit and scope of this description and the claims. In some instances, well-known circuits, structures, or techniques have not been shown or described in detail as these are known to one of ordinary skill in the art.

In this description, specific details are set forth describing some embodiments consistent with the present disclosure. Numerous specific details are set forth in order to provide a thorough understanding of the embodiments. It will be apparent, however, to one of ordinary skill in the art that some embodiments may be practiced without some or all of these specific details. The specific embodiments disclosed herein are meant to be illustrative but not limiting. One of ordinary skill in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

The systems and methods described herein relate to generation of customer interaction insights based on a set of interaction characteristics that are of particular interest to a user. In various embodiments, a user selects an interaction between a customer and a contact center agent. Input data comprising interaction information about the selected interaction is received by a processor. The input data is generated based on analyzing an interaction transcript of the selected interaction using a template associated with the user. The template comprises the set of interaction characteristics that are of particular interest to the user, and a set of predetermined thresholds based on the set of interaction characteristics. The interaction information is analyzed, by the processor, using the set of predetermined thresholds for the set of interaction characteristics. An initial prompt for a large language model (LLM) is generated, by the processor, to generate interaction insights for the selected interaction. The interaction insights are provided to the user for interaction analysis.

In various embodiments, analyzing, by the processor, the interaction information further comprises determining whether the set of predetermined thresholds has been met. Interaction characteristics of the set of interaction characteristics that meet the set of predetermined thresholds are used to generate the initial prompt for the LLM. Interaction characteristics of the set of interaction characteristics that do not meet the set of predetermined thresholds are not used to generate the initial prompt for the LLM. The set of characteristics may comprise customer identification, interaction duration, number of holds in the interaction, duration of holds in the interaction, total handling time, customer sentiment, agent sentiment, agent behavioral metrics, topic categories, or a combination thereof.

In certain embodiments, the interaction may be tagged, by the processor, based on the generated interaction insights to facilitate further activities, which may include one or more of quality planning, automation of quality analysis, training, or a combination thereof.

In several embodiments, the initial prompt may be used by the processor to generate one or more additional prompts for the LLM, based on user input, additional selected customer interactions, or a combination thereof.

In various embodiments, a selected interaction insight generated for one or more interactions may be analyzed, by the processor. In certain embodiments, a selected interaction characteristic generated for one or more interactions may be analyzed, by the processor.

In one or more embodiments, the system may include at least one processor and a non-transitory computer readable storage medium containing instructions which, when executed on the one or more data processors, cause the one or more data processors to perform any of the methods disclosed herein is provided. In one or more embodiments, a computer-program product tangibly embodied in a non-transitory machine-readable storage medium, including instructions configured to cause one or more data processors to perform any of the methods disclosed herein, is provided.

The embodiments described herein improve one or more technical fields, such as for example the technical field of analyzing customer interactions. For example, the embodiments described herein improve the technical field of analyzing customer interactions by allowing a user to customize generation of customer interaction insights based on the user's intended analysis of the interaction, which provides for increased efficiency in the user evaluating such insights thereby saving the user meaningful time and permitting increased throughput of customer interactions by that user or providing the user additional saved time to handle other tasks.

This example improvement is due to the described embodiments providing a technical solution (e.g., generating an initial prompt for a large language model that has been tailored to the user's role and/or interest in the interaction) to a technical problem (e.g., lack of customization and efficiency in generating customer interaction insights for interaction analysis).

In some embodiments, the embodiments described herein include an unconventional combination of steps that results in improvements to the technical field of analyzing customer interactions. For example, the combination of steps associated with generating an initial prompt using a user-specific template to assess an interaction based on a set of interaction characteristics and corresponding predetermined thresholds is associated with generating insights that are more concise, and more accurate to a user's needs, and in some cases, may be associated with analysis of customer interactions corresponding to analysis techniques that are currently unknown in the technical field.

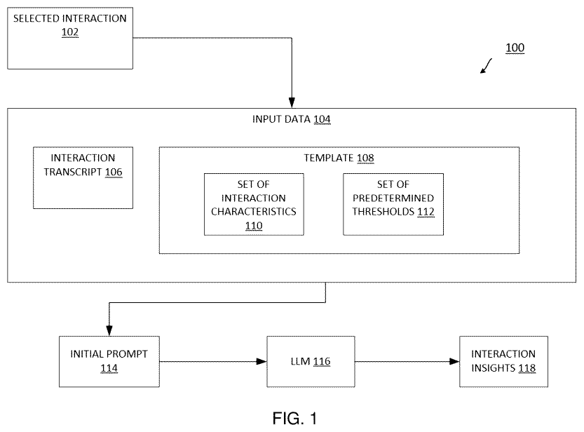

FIG. 1 illustrates data flow in an example customer interaction insights generation system 100 (also referred to as “insights generation system 100” herein) according to some embodiments of the present disclosure.

As shown, insights generation system 100 may include or implement a plurality of devices, processors, servers, and/or software components that operate to perform various methodologies in accordance with the described embodiments. Exemplary devices and servers may include device, stand-alone, and enterprise-class servers, operating an operating system (OS) such as a MICROSOFT® OS, a UNIX® OS, a LINUX® OS, or another suitable device and/or server-based OS. It will be appreciated that the devices and/or servers illustrated in FIG. 1 may be deployed in other ways and that the operations performed, and/or the services provided, by such devices and/or servers may be combined or separated for a given embodiment and may be performed by a greater number or fewer number of devices and/or servers. For example, machine learning (ML), neural network (NN), and other artificial intelligence (AI) architectures have been developed to improve predictive analysis and classifications by systems in a manner similar to human decision-making, which increases efficiency and speed in performing predictive analysis of transaction data sets. One or more devices and/or servers may be operated and/or maintained by the same or different entities.

As shown, data in insights generation system 100 includes selected interaction 102, input data 104, interaction transcript 106, template 108, set of interaction characteristics 110, set of predetermined thresholds 112, initial prompt 114, and interaction insights 118.

At any given point in time, a user of schedule management system 100 may select one or more interactions (e.g., selected interaction(s) 102). In one or more embodiments, the selected interaction 102 may be an interaction between a customer and a contact center agent. In some embodiments, a user of schedule management system may include an employee of a contact center, such as a supervisor, manager, quality management evaluator, etc.

In one or more embodiments, schedule management system 100 may receive input data comprising interaction information about the selected interaction 102. Input data may be generated based on analyzing an interaction transcript (e.g., interaction transcript 106) of the selected interaction 102 based on a template associated with the user (e.g., template 108).

Template 108 may include a set of interaction characteristics that may be of particular interest to the user (e.g., set of interaction characteristics 110), as well as a set of predetermined thresholds based on the set of interaction characteristics (e.g., set of predetermined thresholds 112). The set of interaction characteristics 110 may include customer identification, interaction duration, number of holds in the interaction, duration of holds in the interaction, total handling time, customer sentiment, agent sentiment, agent behavioral metrics, topic categories, or a combination thereof. The set of predetermined thresholds 112 may be qualitative or quantitative thresholds based on the interaction characteristic it is associated with. A user of insights generation system 100 may edit the template 108 to include additional, different, or fewer interaction characteristics as desired in the set of interaction characteristics 110, or may edit the template 108 by changing one or more predetermined thresholds of the set of predetermined thresholds 112 based on the set of interaction characteristics 110 as desired.

In one or more embodiments, interaction information about the selected interaction 102 may be analyzed by using the set of predetermined thresholds 112 for the set of interaction characteristics 110. In some embodiments, analyzing the interaction information may include determining whether the set of predetermined thresholds based on the set of interaction characteristics has been met.

In one or more embodiments, an initial prompt (e.g., initial prompt 114) for a large language model (LLM) (e.g., LLM 116) may be generated in order to generate interaction insights (e.g., interaction insights 118) for the selected interaction (e.g., selected interaction 102). In some embodiments, initial prompt 114 may be generated based on whether an interaction characteristic of the set of interaction characteristics meets its associated predetermined threshold of the set of predetermined thresholds. For example, interaction characteristics of the set of interaction characteristics that meet the set of predetermined thresholds may be used to generate initial prompt 114 for LLM 116, while interaction characteristics of the set of interaction characteristics that do not meet the set of predetermined thresholds may not be used to generate initial prompt 114 for LLM 116.

In one or more embodiments, interaction insights 118 for the selected interaction 102 are provided to the user for interaction analysis.

In some embodiments, initial prompt 114 may be used to generate one or more additional prompts for LLM 116, based on user input, additional selected customer interactions, or a combination thereof. In one or more embodiments, a prompt for LLM 116 may be generated each time a user selects an interaction. For example, a user may select one or more interactions to be analyzed all at once, or may select an additional interaction to be analyzed after an initial prompt 114 is generated for a first selected interaction. In some embodiments, selection of interaction(s) by the user and generation of initial prompt(s) 114 is a dynamic and/or iterative process.

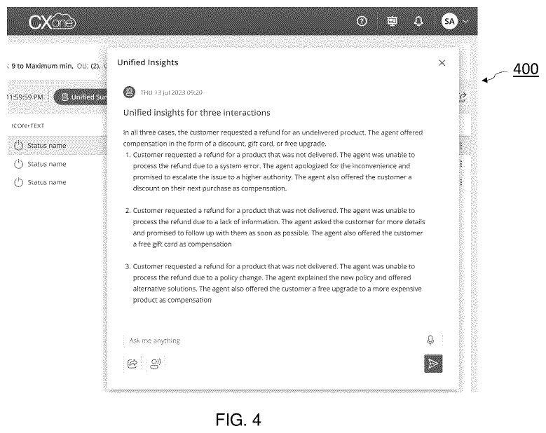

In one or more embodiments, a selected interaction insight of interaction insights 118, that has been generated for a set of customer interactions may be analyzed. For example, a user may view a set of customer interactions for which a specific interaction insight has been generated as interaction insights 118. An example user interface for such embodiments is discussed further with respect to FIG. 4 below.

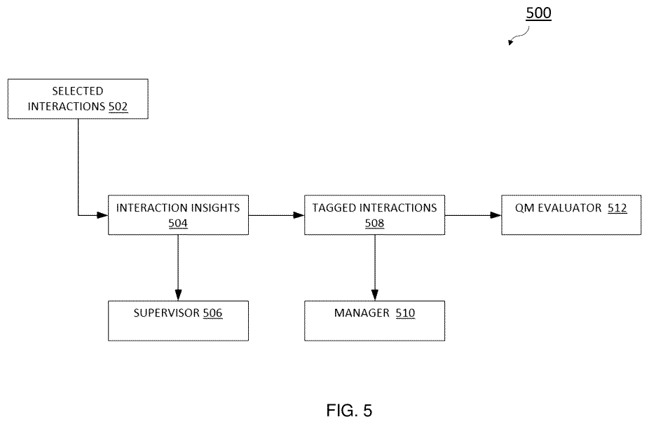

In some embodiments, the selected interaction 102 may be tagged based on the interaction insights 118 to facilitate further activities, which may include one or more of quality planning, automation of quality analysis, training, or a combination thereof. Use of interaction insights 118 and tagged interactions is discussed further with respect to FIG. 5 below.

In one or more embodiments, insights generation system 100 may generate interaction insights (e.g., interaction insights 118) using a trained machine learning model. The machine learning model may be trained using training data that includes example customer interaction inputs and correlated example prompts generated for an LLM (e.g., LLM 116). The example customer interaction inputs may include a training set of customer interactions between a customer and a contact center agent, and corresponding interaction characteristics and predetermined thresholds based on the interaction characteristics, for each interaction of the training set of interactions. In some embodiments, training the machine learning model may include modifying one or more weights of one or more nodes of an artificial neural network.

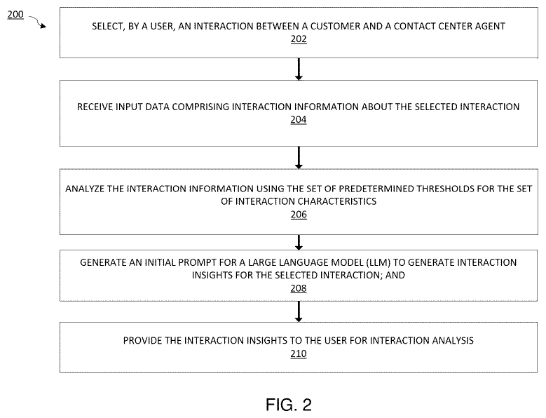

FIG. 2 is an exemplary flowchart 200 for customer interaction insights generation according to embodiments of the present disclosure. Note that one or more steps, processes, and methods described herein of flowchart 200 may be omitted, performed in a different sequence, or combined as desired or appropriate based on the guidance provided herein. Flowchart 200 of FIG. 2 includes operations for customer interaction insights generation, as discussed in reference to FIG. 1. One or more of steps 202-210 of flowchart 200 may be implemented, at least in part, in the form of executable code stored on non-transitory, tangible, machine-readable media that when run by one or more processors may cause the one or more processors to perform one or more of steps 202-210. In some embodiments, flowchart 200 can be performed by one or more computing devices discussed in schedule management system 100 of FIG. 1.

Accordingly, at step 202 of flowchart 200, a user of customer interaction insights generation system 100 selects an interaction between a customer and a contact center agent (e.g., selected interaction 102 in FIG. 1). In one or more embodiments, the selected interaction 102 may be an interaction between a customer and a contact center agent. In some embodiments, a user of schedule management system may include an employee of a contact center, such as a supervisor, manager, quality management evaluator, etc.

At step 204 of flowchart 200, customer interaction insights generation system 100 receives input data comprising interaction information about the selected interaction (e.g., selected interaction 102). Input data may be generated based on analyzing an interaction transcript (e.g., interaction transcript 106) of the selected interaction 102 based on a template associated with the user (e.g., template 108).

Template 108 may include a set of interaction characteristics that may be of particular interest to the user (e.g., set of interaction characteristics 110), as well as a set of predetermined thresholds based on the set of interaction characteristics (e.g., set of predetermined thresholds 112). The set of interaction characteristics 110 may include customer identification, interaction duration, number of holds in the interaction, duration of holds in the interaction, total handling time, customer sentiment, agent sentiment, agent behavioral metrics, topic categories, or a combination thereof. The set of predetermined thresholds 112 may be qualitative or quantitative thresholds based on the interaction characteristic it is associated with. A user of insights generation system 100 may edit the template 108 to include additional or fewer interaction characteristics as desired in the set of interaction characteristics 110, or may edit the template 108 by changing one or more predetermined thresholds of the set of predetermined thresholds 112 based on the set of interaction characteristics 110 as desired.

At step 206 of flowchart 200, customer interaction insights generation system 100 analyzes the interaction information using the set of predetermined thresholds for the set of interaction characteristics. In one or more embodiments, interaction information about the selected interaction 102 may be analyzed by using the set of predetermined thresholds 112 for the set of interaction characteristics 110. In some embodiments, analyzing the interaction information may include determining whether the set of predetermined thresholds based on the set of interaction characteristics has been met.

At step 208 of flowchart 200, customer interaction insights generation system 100 generates an initial prompt for a large language model (LLM) to generate interaction insights for the selected interaction. In one or more embodiments, an initial prompt (e.g., initial prompt 114) for a large language model (LLM) (e.g., LLM 116) may be generated in order to generate interaction insights (e.g., interaction insights 118) for the selected interaction (e.g., selected interaction 102). In some embodiments, initial prompt 114 may be generated based on whether an interaction characteristic of the set of interaction characteristics meets its associated predetermined threshold of the set of predetermined thresholds. For example, interaction characteristics of the set of interaction characteristics that meet the set of predetermined thresholds may be used to generate initial prompt 114 for LLM 116, while interaction characteristics of the set of interaction characteristics that do not meet the set of predetermined thresholds may not be used to generate initial prompt 114 for LLM 116.

At step 210 of flowchart 200, interaction insights are provided to the user for interaction analysis.

In some embodiments, initial prompt 114 may be used to generate one or more additional prompts for LLM 116, based on user input, additional selected customer interactions, or a combination thereof. In one or more embodiments, a prompt for LLM 116 may be generated each time a user selects an interaction. For example, a user may select one or more interactions to be analyzed all at once, or may select an additional interaction to be analyzed after an initial prompt 114 is generated for a first selected interaction. In some embodiments, selection of interaction(s) by the user and generation of initial prompt(s) 114 is a dynamic and/or iterative process.

In one or more embodiments, a selected interaction insight of interaction insights 118, that has been generated for a set of customer interactions may be analyzed. For example, a user may view a set of customer interactions for which a specific interaction insight has been generated as interaction insights 118. An example user interface for such embodiments is discussed further with respect to FIG. 4 below.

In some embodiments, the selected interaction 102 may be tagged based on the interaction insights 118 to facilitate further activities, which may include one or more of quality planning, automation of quality analysis, training, or a combination thereof. Use of interaction insights 118 and tagged interactions is discussed further with respect to FIG. 5 below.

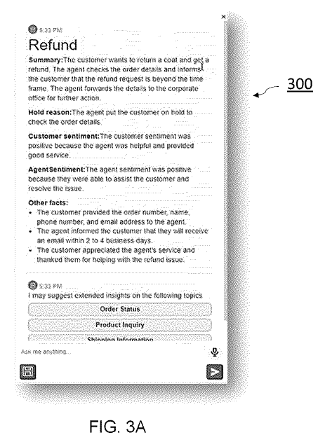

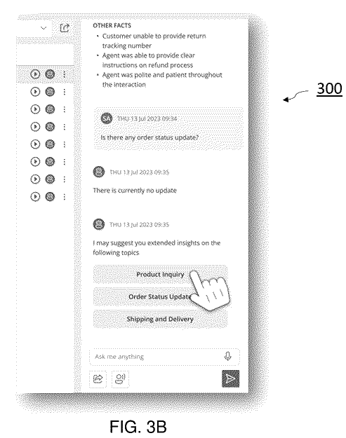

FIGS. 3A and 3B is an exemplary views of a user interface 300 for receiving interaction insights once generated by the customer interaction insights generation system 100 as discussed above with respect to FIGS. 1 and 2. In FIG. 3A, interaction insights for a selected interaction (e.g., selected interaction 102 of FIG. 1) are provided to the user, including details for various interaction characteristics. In FIG. 3B, after receiving the interaction insights as shown in FIG. 3A, the user has asked an additional question to the LLM (e.g., LLM 116) of customer interaction insights generation system 100, to obtain further details concerning order status updates. Customer interaction insights generation system 100 provides an answer, and then offers to generate one or more additional prompts for the LLM, such that the user may analyze additional interaction characteristics.

FIG. 4 is an exemplary view of a user interface 400 for filtering interaction insights generated for a set of interactions. For example, in FIG. 4, a user has requested information regarding interactions for which interaction insights related to a refund issue have been generated. In one or more embodiments, interaction insights related to a refund issue may be generated when an interaction is identified as meeting a predetermined threshold of discussing a refund for the interaction characteristic of topic category. Exemplary topic categories may include refund or other billing or payment issues, additional product or service purchase, customer satisfaction/dissatisfaction, repair service, subscription/renewal issues, pricing issues, customer support issues, or the like.

FIG. 5 illustrates exemplary data flow 500 for how interaction insights generated for a selected interaction, by the customer interaction insights generation system 100 as discussed above with respect to FIGS. 1 and 2, may be further analyzed by various employees of a contact center (e.g., various users of insights generation system 100). In one or more embodiments, interaction insights (e.g., interaction insights 504) are generated for one or more selected interactions (e.g., selected interactions 502). In some embodiments, interaction insights 504 may be analyzed by a supervisor (e.g., supervisor 506) of the contact center agent with which the selected customer interactions occurred. For example, supervisor 506 may analyze interaction insights 504 to analyze why an agent's customer interactions are usually over a long duration of time, why an agent's customer interactions have long hold times in which the customer is kept waiting, why an agent's customer interactions have an unusually low success rate relative to a previous time period for that agent or relative to an average of a plurality of similarly skilled agents, or other applicable criteria or combinations of criteria the supervisor 506 wishes to analyze.

In some embodiments, selected interactions 502 may be tagged based on associated interaction insights (e.g., tagged interactions 508). In one or more embodiments, tagged interactions 508 may be used by a manager (e.g., manager 510) to analyze contact center training needs, quality management needs, or a combination thereof. In one or more embodiments, manager 510 may use tagged interactions 508 to analyze interaction insights that may indicate a need for additional training for contact center agents and/or supervisors. For example, manager 510 may identify a set of tagged interactions 508 for which an interaction insight of negative customer-sentiment has been generated. In such cases, manager 510 may have included in its user-specific template (e.g., template 108 of FIG. 1) an interaction characteristic of customer-sentiment, and set the associated predetermined threshold as including negative customer-sentiments such as anger, frustration, raised-volume, or the like.

In various embodiments, tagged interactions 508 may additionally be used by a quality management evaluator (e.g., QM evaluator 512) in automation of quality analysis. In some embodiments, QM evaluator 512 may continuously generate interaction insights for customer interactions in order to monitor overall customer satisfaction, quality of customer interactions, or a combination thereof. In such cases, tagged interactions 508 may allow QM evaluator 512 to quickly identify customer interactions of lesser quality based on their generated interaction insights being tagged as meeting predetermined thresholds of interaction characteristics that are associated with poor customer interaction quality. For example, QM evaluator 512 may have included in its user-specific template (e.g., template 108 of FIG. 1) interaction characteristics related to hold times, handling-time, and number of holds, and may have set the associated predetermined thresholds to flag long hold times, long handling-times, and high number of holds.

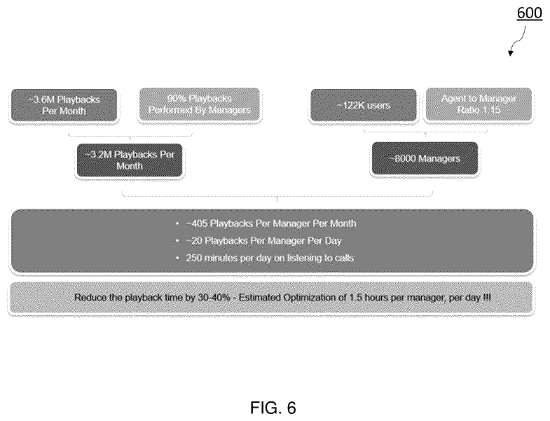

FIG. 6 is an exemplary flowchart 600 illustrating improvements in customer interaction analysis in an exemplary contact center organization environment. As shown, the contact center organization may require approximately 3.6 million playbacks of customer interactions per month, 90% of which are performed by approximately 8000 managers. This results in each manager spending roughly four hours per day simply to review customer interactions. By using the customer interaction insights generation system 100 as discussed above with respect to FIGS. 1 and 2, playback time for each manager may be reduced by 30-40%, such that approximately 1.5 hours of playback time are freed up for each manager, each day, resulting in significantly increased efficiencies in customer interactions, contact center efficiencies, and throughput of workflow for supervisors.

Below are examples of full data structures usable with the present disclosure.

1. Example role-specific template:

```
{
  “duration”=5;
  “hold-count”=2;
  “hold-duration”=30;
  “total-handling-time”=4;
  “customer-sentiment”=[‘bad’];
  “agent-sentiment”=[‘good’];
  ...
  ...
}
```

Where applicable, various embodiments provided by the present disclosure may be implemented using hardware, software, or combinations of hardware and software. Also, where applicable, the various hardware components and/or software components set forth herein may be combined into composite components including software, hardware, and/or both without departing from the spirit of the present disclosure. Where applicable, the various hardware components and/or software components set forth herein may be separated into sub-components including software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

Although illustrative embodiments have been shown and described, a wide range of modifications, changes and substitutions are contemplated in the foregoing disclosure and in some instances, some features of the embodiments may be employed without a corresponding use of other features. One of ordinary skill in the art would recognize many variations, alternatives, and modifications of the foregoing disclosure. Thus, the scope of the present application should be limited only by the following claims, and it is appropriate that the claims be construed broadly and in a manner consistent with the spirit and full scope of the embodiments disclosed herein.

The Abstract at the end of this disclosure is provided to comply with 37 C.F.R. § 1.72 (b) to allow a quick determination of the nature of the technical disclosure. It is submitted with the understanding that it will not be used to interpret or limit the scope or meaning of the claims.

What is claimed is:

1. A computer-implemented method of generating customer interaction insights based on a set of interaction characteristics that are of particular interest to a user, which comprises:
selecting, by the user, an interaction between a customer and a contact center agent;
receiving input data, by a processor, comprising interaction information about the selected interaction,
wherein the input data is generated based on analyzing an interaction transcript of the selected interaction using a template associated with the user, and
wherein the template comprises the set of interaction characteristics that are of particular interest to the user, and a set of predetermined thresholds based on the set of interaction characteristics;
analyzing, by the processor, the interaction information using the set of predetermined thresholds for the set of interaction characteristics;
generating, by the processor, an initial prompt for a large language model (LLM), to generate interaction insights for the selected interaction; and
providing the interaction insights to the user for interaction analysis.

2. The computer-implemented method of claim 1, wherein analyzing, by the processor, the interaction information further comprises:
determining whether the set of predetermined thresholds based on the set of interaction characteristics has been met,
wherein interaction characteristics of the set of interaction characteristics that meet the set of predetermined thresholds are used to generate the initial prompt for the LLM, and
wherein interaction characteristics of the set of interaction characteristics that do not meet the set of predetermined thresholds are not used to generate the initial prompt for the LLM.

3. The computer-implemented method of claim 1, wherein the set of characteristics comprises customer identification, interaction duration, number of holds in the interaction, duration of holds in the interaction, total handling time, customer sentiment, agent sentiment, agent behavioral metrics, topic categories, or a combination thereof.

4. The computer-implemented method of claim 1, which further comprises the processor tagging the interaction based on the interaction insights to facilitate further activities including one or more of quality planning, automation of quality analysis, training, or a combination thereof.

5. The computer-implemented method of claim 1, which further comprises the processor using the initial prompt to generate one or more additional prompts for the LLM, based on user input, additional selected customer interactions, or a combination thereof.

6. The computer-implemented method of claim 1, which further comprises analyzing, by a processor, a selected interaction insight generated for one or more interactions.

7. The computer-implemented method of claim 1, which further comprises analyzing, by a processor, a selected interaction characteristic generated for one or more interactions.

8. A customer interaction insights generation system, based on a set of interaction characteristics that are of particular interest to a user, comprising at least one processor and a non-transitory computer readable medium operably coupled thereto, the non-transitory computer readable medium comprising a plurality of instructions stored in association therewith that are accessible to, and executable by, the at least one processor, to perform operations which comprise:
selecting, by the user, an interaction between a customer and a contact center agent;
receiving input data comprising interaction information about the selected interaction,
wherein the input data is generated based on analyzing an interaction transcript of the selected interaction using a template associated with the user, and
wherein the template comprises the set of interaction characteristics that may be of particular interest to the user, and a set of predetermined thresholds based on the set of interaction characteristics;
analyzing the interaction information using the set of predetermined thresholds for the set of interaction characteristics;
generating an initial prompt for a large language model (LLM) to generate interaction insights for the selected interaction; and
providing the interaction insights to the user for interaction analysis.

9. The system of claim 8, wherein analyzing the interaction information further comprises:
determining whether the set of predetermined thresholds based on the set of interaction characteristics has been met,
wherein interaction characteristics of the set of interaction characteristics that meet the set of predetermined thresholds are used to generate the initial prompt for the LLM, and
wherein interaction characteristics of the set of interaction characteristics that do not meet the set of predetermined thresholds are not used to generate the initial prompt for the LLM.

10. The system of claim 8, wherein the set of characteristics comprises customer identification, interaction duration, number of holds in the interaction, duration of holds in the interaction, total handling time, customer sentiment, agent sentiment, agent behavioral metrics, topic categories, or a combination thereof.

11. The system of claim 8, which further comprises tagging the interaction based on the interaction insights to facilitate further activities including one or more of quality planning, automation of quality analysis, training, or a combination thereof.

12. The system of claim 8, which further comprises using the initial prompt to generate one or more additional prompts for the LLM, based on user input, additional selected customer interactions, or a combination thereof.

13. The system of claim 8, which further comprises analyzing a selected interaction insight generated for one or more interactions.

14. The system of claim 8, which further comprises analyzing a selected interaction characteristic generated for one or more interactions.

15. A non-transitory computer-readable medium having stored thereon computer-readable instructions executable by at least one processor to perform operations which comprise:
selecting, by a user, an interaction between a customer and a contact center agent;
receiving input data comprising interaction information about the selected interaction,
wherein the input data is generated based on analyzing an interaction transcript of the selected interaction using a template associated with the user, and
wherein the template comprises a set of interaction characteristics that may be of particular interest to the user, and a set of predetermined thresholds based on the set of interaction characteristics;
analyzing the interaction information using the set of predetermined thresholds for the set of interaction characteristics;
generating an initial prompt for a large language model (LLM) to generate interaction insights for the selected interaction; and
providing the interaction insights to the user for interaction analysis.

16. The non-transitory computer-readable medium of claim 15, wherein analyzing the interaction information further comprises:
determining whether the set of predetermined thresholds based on the set of interaction characteristics has been met,
wherein interaction characteristics of the set of interaction characteristics that meet the set of predetermined thresholds are used to generate the initial prompt for the LLM, and
wherein interaction characteristics of the set of interaction characteristics that do not meet the set of predetermined thresholds are not used to generate the initial prompt for the LLM.

17. The non-transitory computer-readable medium of claim 15, wherein the set of characteristics comprises customer identification, interaction duration, number of holds in the interaction, duration of holds in the interaction, total handling time, customer sentiment, agent sentiment, agent behavioral metrics, topic categories, or a combination thereof.

18. The non-transitory computer-readable medium of claim 15, which further comprises tagging the interaction based on the interaction insights to facilitate further activities including one or more of quality planning, automation of quality analysis, training, or a combination thereof.

19. The non-transitory computer-readable medium of claim 15, which further comprises using the initial prompt to generate one or more additional prompts for the LLM, based on user input, additional customer interaction, or a combination thereof.

20. The non-transitory computer-readable medium of claim 15, which further comprises analyzing a selected interaction insight, or a selected interaction characteristic, generated for one or more interactions.
